(19) United States
(12) Patent Application Publication
(10) Pub. No.: US 2021/0116087 A1
(43) Pub. Date: Apr. 22, 2021

(54) LIGHTING APPARATUS

(71) Applicant: XIAMEN LEEDARSON LIGHTING CO.,LTD, Xiamen (CN)

(72) Inventors: Wenjin Peng, Xiamen (CN); Xiaoliang Wen, Xiamen (CN); Shouqiang Hou, Xiamen (CN)

(21) Appl. No.: 17/073,259

(22) Filed: Oct. 16, 2020

(30) Foreign Application Priority Data
Oct. 16, 2019 (CN) 201921737469.8

(51) Int. Cl. F21S 8/04; F21V 3/02; F21V 21/03; F21V 33/00; F21K 9/69; F21V 23/00; H05B 47/19

(52) U.S. Cl. CPC F21S 8/043; F21V 3/02; F21V 21/03; F21Y 2115/10; F21K 9/69; F21V 23/009; H05B 47/19; F21V 33/0056

(57) ABSTRACT

A lighting apparatus includes a rim wall, a diffusion cover, a base plate, a driver module, a light source module and a fixing structure. The rim wall has top edge and a bottom edge. The diffusion cover has a central hole. The diffusion cover is fixed to the top edge of the rim wall. The central cover is fixed to the central hole. The base plate is fixed to the bottom edge of the rim wall. The driver module is fixed to a center portion of the base plate facing to the central cover. The light source module has multiple LED strips surrounding the driver module. The fixing structure is fixed to a flat surface of the bottom plate. The fixing structure has sliding grooves for inserting fixing ends of a fixing bracket.

### FIELD

The present invention is related to a lighting apparatus, and more particularly related to a lighting apparatus with easy assembly function.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

It is important to consider assembly of light devices.

Therefore, it is beneficial to design a lighting device that has convenient and flexible assembly capability.

### SUMMARY

In some embodiments, a lighting apparatus includes a rim wall, a diffusion cover, a base plate, a driver module, a light source module and a fixing structure.

The rim wall has top edge and a bottom edge.

The diffusion cover has a central hole.

The diffusion cover is fixed to the top edge of the rim wall.

The central cover is fixed to the central hole.

The base plate is fixed to the bottom edge of the rim wall.

The driver module is fixed to a center portion of the base plate facing to the central cover.

The light source module has multiple LED strips surrounding the driver module.

The fixing structure is fixed to a flat surface of the bottom plate.

The fixing structure has sliding grooves for inserting fixing ends of a fixing bracket.

The fixing bracket is fixed to an installation platform first, users hold and rotate the rim wall to slide the fixing ends of the fixing bracket respectively to the sliding grooves to fix the lighting apparatus to the installation platform.

In some embodiments, there are two sliding grooves and the fixing bracket is a bar with two ends as the fixing ends.

The bar is fixed to a ceiling first. Two opposite ends of the bar are the fixing ends. The two opposite ends are inserted into the sliding grooves and the rim wall is rotated to carry the sliding grooves rotate with respect to the bar and thus the two opposite ends are kept in the sliding grooves, making the lighting apparatus to fix to the ceiling.

With such design, the lighting apparatus is easily to be removed or installed to the ceiling. Only a simple bar is left and makes the assembly easy and elegant.

In some embodiments, the fixing structure is a ring structure protruding from the flat surface of the bottom plate.

In some embodiments, the fixing structure has a guiding part, an anti-reverse stop block.

An anti-reverse track and a stop block along the sliding groove.

In some embodiments, the fixing bracket has an electrode terminal electrically connected to an external power source.

In some embodiments, the LED strips includes multiple LED modules.

Each LED module has a diffusion lens covering a LED chip for diffusing a light of the LED chip.

In some embodiments, a distance between adjacent LED modules is as a first value.

A distance between the LED module to the light passing cover is a second value.

A ratio between the first value to the second value is less than 5.

In some embodiments, the central cover is detachably attached to a top surface of the driver module.

The central cover is detached from the driver module to be replaced with another central cover.

In some embodiments, the driver module has an electrode terminal to supply power to an electronic device on the central cover.

In some embodiments, the driver module is connected to the central cover with a magnetic unit.

In some embodiments, the central cover has a second light source for emitting a second light.

In some embodiments, the central cover has a camera module electrically connected to the driver module.

In some embodiments, the central cover has a speaker electrically connected to the driver module.

In some embodiments, the central cover is a manual switch for adjusting a control mode of the driver module.

In some embodiments, the central cover is pressed to be operated.

In some embodiments, there are multiple angles to place the central cover.

Each angle is corresponding to a different setting of the driver module.

In some embodiments, the central cover includes a wireless circuit as a module.

The driver module uses a different wireless protocol by attaching a different central cover with one corresponding wireless circuit.

In some embodiments, the central cover is attached with a filter ring covering the diffusing cover.

In some embodiments, the filter ring surpasses blue light of the light source.

In some embodiments, a detachable skin is attached to the rim wall.

In some embodiments, an inner side of the rim wall has a reflective surface.

### BRIEF DESCRIPTION OF DRAWINGS

FIG. 1 illustrates an exploded view of a lighting apparatus embodiment.

FIG. 2 illustrates a perspective view of a back side of the example in FIG. 1.

FIG. 3 illustrates an operation on the example of FIG. 1.

FIG. 4 illustrates an assembly diagram of the example in FIG. 1.

FIG. 5 illustrates a top view of the example.

FIG. 6 illustrates a component of an example for fixing units.

FIG. 7 illustrates a component in an example.

FIG. 8 illustrates a component corresponding to the component in FIG. 7.

FIG. 9 illustrates a front view of the example in FIG. 1.

FIG. 10 illustrates an exploded view of components in an example.

FIG. 11 illustrates an installation diagram of the example.

FIG. 12 illustrates another step during assembly.

FIG. 13 illustrates another step during assembly.

FIG. 14 shows a lighting apparatus embodiment.

FIG. 15 shows a fixing structure component.

FIG. 16 shows parameter calculation.

FIG. 17 shows a setting design.

FIG. 18 shows a central cover with a filter ring.

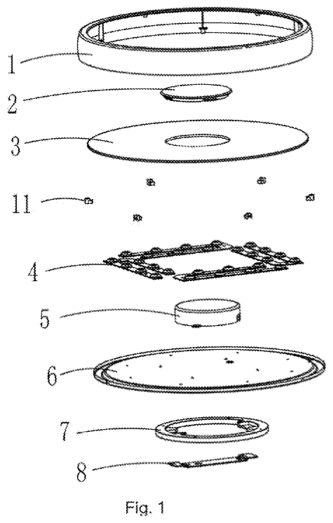

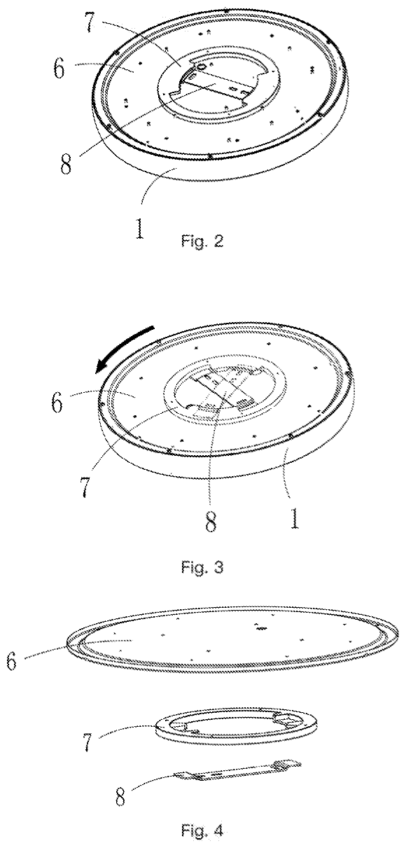

### DETAILED DESCRIPTION

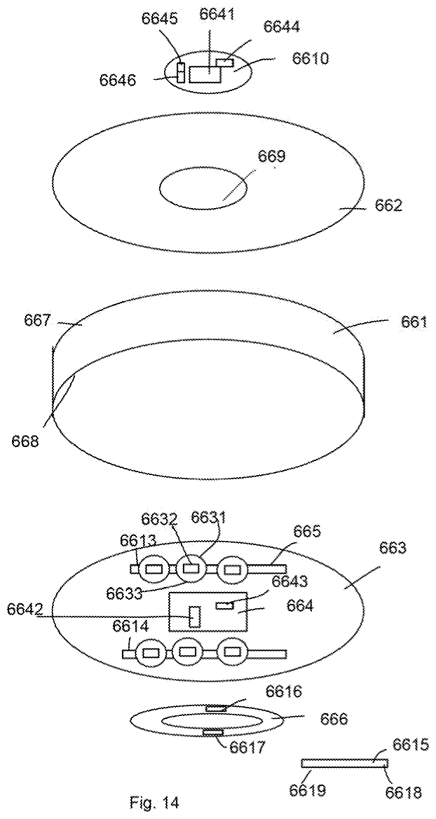

In FIG. 14, a lighting apparatus includes a rim wall 661, a diffusion cover 662, a base plate 663, a driver module 664, a light source module 665 and a fixing structure 666.

The rim wall 661 has top edge 667 and a bottom edge 668.

The diffusion cover 662 has a central hole 669.

The diffusion cover 662 is fixed to the top edge 667 of the rim wall 661.

The central cover 6610 is fixed to the central hole 669.

The base plate 663 is fixed to the bottom edge 668 of the rim wall 661.

The driver module 664 is fixed to a center portion of the base plate 663 facing to the central cover 6610.

The light source module 665 has multiple LED strips 6613, 6614 surrounding the driver module 664.

The fixing structure 666 is fixed to a flat surface of the bottom plate 663. Specifically, the back surface is completely flat or has a main flat portion. The fixing structure 666 may be a ring structure. When the fixing structure 666 is fixed to the bottom plate 663, there is a protruding structure extending from the flat surface of the exterior surface of the bottom plate 663.

The fixing structure 666 has sliding grooves 6616, 6617 for inserting fixing ends 6618, 6619 of a fixing bracket 6615.

The fixing bracket 6615 is fixed to an installation platform, e.g. a ceiling, first. Users hold and rotate the rim wall 661 to slide the fixing ends 6618, 6619 of the fixing bracket 6615 respectively to the sliding grooves 6616, 6617 to fix the lighting apparatus to the installation platform.

In some embodiments, there are two sliding grooves and the fixing bracket is a bar with two ends as the fixing ends.

The bar is fixed to a ceiling first. Two opposite ends of the bar are the fixing ends. The two opposite ends are inserted into the sliding grooves and the rim wall is rotated to carry the sliding grooves rotate with respect to the bar and thus the two opposite ends are kept in the sliding grooves, making the lighting apparatus to fix to the ceiling.

With such design, the lighting apparatus is easily to be removed or installed to the ceiling. Only a simple bar is left and makes the assembly easy and elegant.

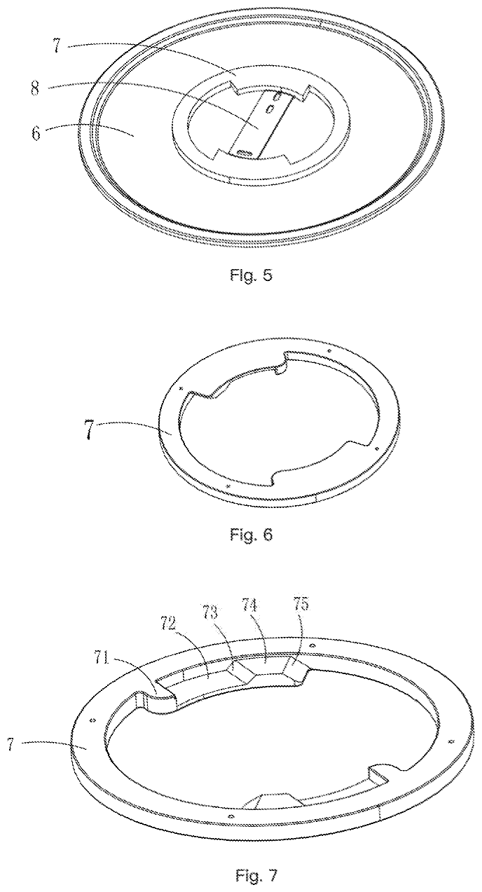

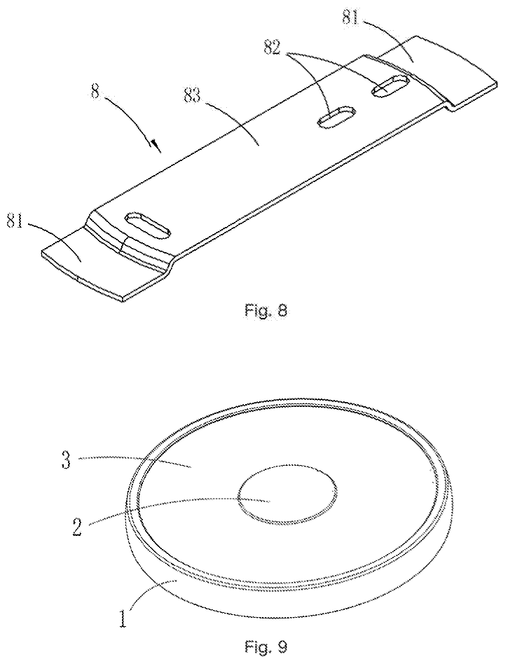

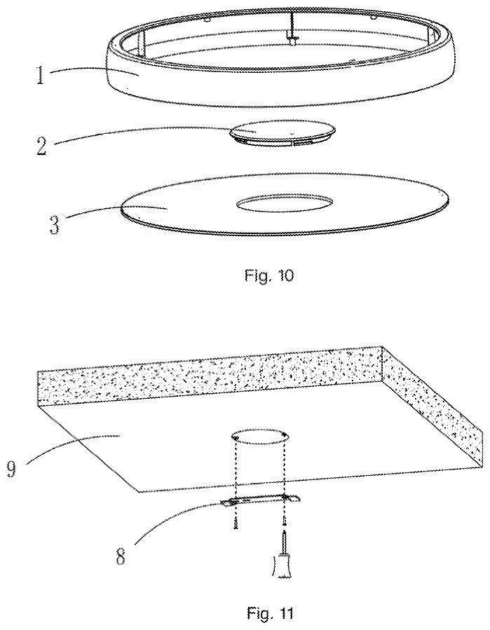

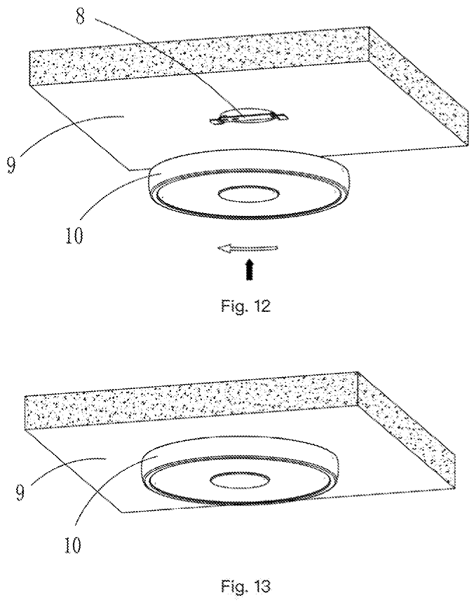

In some embodiments, the fixing structure is a ring structure protruding from the flat surface of the bottom plate, as the example illustrated in FIG. 6 and FIG. 7.

In FIG. 7, the fixing structure 7 has a guiding part 75, an anti-reverse stop block 74, an anti-reverse track 72 and a stop block 71 along the sliding groove. There is a guiding surface 73 for exit, too.

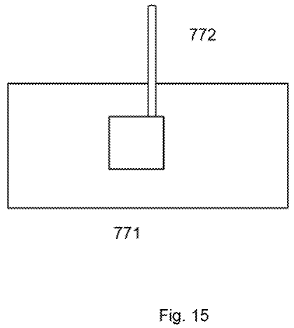

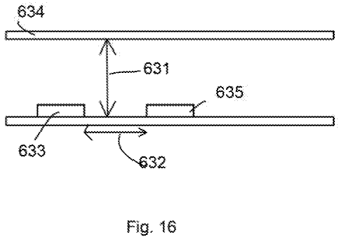

In FIG. 15, the fixing bracket has an electrode terminal 771 electrically connected to an external power source 772. There is a corresponding electrode terminal on the back side of the bottom plate so that when the lighting apparatus is fixed to the fixing bracket, the electrical contact is performed with the electrode terminal 771. With such design, users do not need to remove the light passing cover to connect wires to the driver module of the lighting apparatus.

In some embodiments, the LED strips 665 includes multiple LED modules 6631.

Each LED module 6631 has a diffusion lens 6633 covering a LED chip 6632 for diffusing a light of the LED chip 6632.

In some embodiments, a distance between adjacent LED modules 633, 635 is as a first value 632.

A distance between the LED module 633 to the light passing cover 634 is a second value 631.

A ratio between the first value 632 to the second value 631 is less than 5, or preferably less than 2.5.

In some embodiments, the central cover is detachably attached to a top surface of the driver module.

The central cover is detached from the driver module to be replaced with another central cover.

In FIG. 14, the driver module has an electrode terminal 6642 to supply power to an electronic device 6641 on the central cover 6610.

In some embodiments, the driver module is connected to the central cover with a magnetic unit 6643.

In some embodiments, the central cover has a second light source 6644 for emitting a second light.

In some embodiments, the central cover has a camera module 6645 electrically connected to the driver module 664.

In some embodiments, the central cover has a speaker 6646 electrically connected to the driver module 664.

In some embodiments, the central cover is a manual switch for adjusting a control mode of the driver module.

In some embodiments, the central cover is pressed to be operated.

In some embodiments, there are multiple angles to place the central cover.

Each angle is corresponding to a different setting of the driver module.

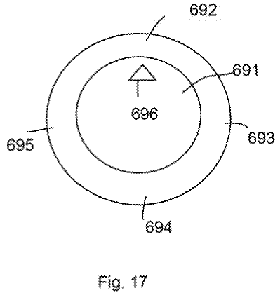

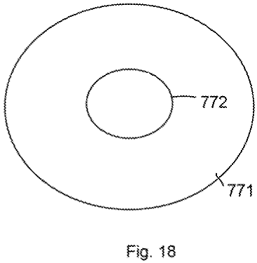

In FIG. 17, the central cover 691 has an indicator 696. By placing the central cover 691 to align its indicator 696 to four different positions 692, 693, 694, 695, a different parameter may be indicated to control the driver module, e.g. four different color temperatures.

In some embodiments, the central cover includes a wireless circuit as a module.

The driver module uses a different wireless protocol by attaching a different central cover with one corresponding wireless circuit.

For example, the lighting devices sold to U.S. market may use a different wireless protocol as European market. When the wireless circuit is located on a detachable central cover, it is easy to replace with different protocols with low stocking cost.

In some embodiments, the central cover 772 is attached with a filter ring 771 covering the diffusing cover. The filter ring 771 may be a film that is light and has no risk to fall down.

In some embodiments, the filter ring surpasses blue light of the light source.

In some embodiments, a detachable skin is attached to the rim wall.

In some embodiments, an inner side of the rim wall has a reflective surface, e.g. with powder, painting of light color, attached with a reflective layer to increase light efficiency.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a rim wall has top edge and a bottom edge;
a diffusion cover with a central hole, wherein the diffusion cover is fixed to the top edge of the rim wall;
a central cover fixed to the central hole;
a base plate fixed to the bottom edge of the rim wall;
a driver module fixed to a center portion of the base plate facing to the central cover;
a light source module with multiple LED strips surrounding the driver module; and
a fixing structure fixed to a flat surface of the bottom plate, wherein the fixing structure has sliding grooves for inserting fixing ends of a fixing bracket, wherein the fixing bracket is fixed to an installation platform first, users hold and rotate the rim wall to slide the fixing ends of the fixing bracket respectively to the sliding grooves to fix the lighting apparatus to the installation platform.

2. The lighting apparatus of claim 1, wherein the fixing structure is a ring structure protruding from the flat surface of the bottom plate.

3. The lighting apparatus of claim 2, wherein the fixing structure has a guiding part, an anti-reverse stop block, an anti-reverse track and a stop block along the sliding groove.

4. The lighting apparatus of claim 1, wherein the fixing bracket has an electrode terminal electrically connected to an external power source.

5. The lighting apparatus of claim 1, wherein the LED strips comprises multiple LED modules, each LED module has a diffusion lens covering a LED chip for diffusing a light of the LED chip.

6. The lighting apparatus of claim 5, wherein a distance between adjacent LED modules is as a first value, a distance between the LED module to the light passing cover is a second value, a ratio between the first value to the second value is less than 5.

7. The lighting apparatus of claim 1, wherein the central cover is detachably attached to a top surface of the driver module, the central cover is detached from the driver module to be replaced with another central cover.

8. The lighting apparatus of claim 7, wherein the driver module has an electrode terminal to supply power to an electronic device on the central cover.

9. The lighting apparatus of claim 7, wherein the driver module is connected to the central cover with a magnetic unit.

10. The lighting apparatus of claim 7, wherein the central cover has a second light source for emitting a second light.

11. The lighting apparatus of claim 7, wherein the central cover has a camera module electrically connected to the driver module.

12. The lighting apparatus of claim 7, wherein the central cover has a speaker electrically connected to the driver module.

13. The lighting apparatus of claim 7, wherein the central cover is a manual switch for adjusting a control mode of the driver module.

14. The lighting apparatus of claim 13, wherein the central cover is pressed to be operated.

15. The lighting apparatus of claim 13, wherein there are multiple angles to place the central cover, each angle is corresponding to a different setting of the driver module.

16. The lighting apparatus of claim 7, wherein the central cover includes a wireless circuit as a module, the driver module uses a different wireless protocol by attaching a different central cover with one corresponding wireless circuit.

17. The lighting apparatus of claim 7, wherein the central cover is attached with a filter ring covering the diffusing cover.

18. The lighting apparatus of claim 17, wherein the filter ring surpasses blue light of the light source.

19. The lighting apparatus of claim 1, wherein a detachable skin is attached to the rim wall.

20. The lighting apparatus of claim 1, wherein an inner side of the rim wall has a reflective surface.
